(19) United States
(12) Patent Application Publication
(10) Pub. No.: US 2007/0138073 A1
(43) Pub. Date: Jun. 21, 2007

(54) DEVICE FOR DISPERSING AND DISTRIBUTING A FLUID

(76) Inventor: David S. Matthews, Ballston Spa, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/671,553

(22) Filed: Feb. 6, 2007

Related U.S. Application Data
(63) Continuation-in-part of application No. 11/402,402, filed on Apr. 12, 2006.
(60) Provisional application No. 60/670,918, filed on Apr. 13, 2005.

(51) Int. Cl. B01D 29/00

(52) U.S. Cl. 210/153

(57) ABSTRACT

The invention provides a device for dispersing and/or distributing a fluid effluent from a pressurized fluid system. In one embodiment, a device according to the invention includes a hitch member adapted for attachment to a vehicle; a tubular member having at least one discharge opening and at least one attachment port adapted for attachment to a pressurized liquid system; and a diffusing device connected to the at least one discharge opening, the diffusing device having a mesh member including a plurality of openings through which a liquid may be dispersed, wherein at least one of the diffusing device and a portion of the tubular member is adapted to be variously oriented in at least one of the following: a horizontal position and a vertical position.

### CROSS-REFERENCE TO RELATED APPLICATIONS

The present application is a continuation-in-part of co-pending U.S. patent application Ser. No. 11/402,402, filed 12 Apr. 2006, which claims the benefit of U.S. Provisional Patent Application No. 60/670,918, filed 13 Apr. 2005, each of which is hereby incorporated by reference.

### BACKGROUND OF THE INVENTION

1. Technical Field

The invention relates generally to flushing devices, and, more particularly, to devices for dispersing and/or distributing a fluid from a pressurized system.

2. Background Art

Pressurized liquid systems, such as municipal water systems and sprinkler systems, require periodic flushing in order to ensure their proper function. For example, municipal or private fire hydrant systems must be periodically flushed to ensure that their hydrants will function properly in the event that they are needed. Sprinkler systems must be periodically flushed for the same reason.

Hydrant systems and sprinkler systems are generally flushed using a fire hydrant or a valve attached to the sprinkler line, respectively. Often, a hose, such as a fire hose, is connected to the hydrant or valve, allowing the system effluent to be discharged some distance from the hydrant or valve. However, flushing pressurized systems using a hose can be inefficient and dangerous, as the hose is apt to move, sometimes with great force, in response to the pressure of the system.

A number of devices have been described for controlling the discharge of effluent from a fire hydrant. For example, Hydro Flow Products, Inc. offers a T-shaped device adapted for attachment to a fire hose, whereby hydrant effluent is discharged perpendicular to the fire hose. However, the direction of effluent discharge is fixed, making its use inapplicable in some locations and/or situations. In addition, when flushing high-pressure systems, such a device is still apt to move making the added weight of the T-shaped device an additional hazard to those nearby.

A number of vehicle-mounted devices are available from pollardwater.com. However, such devices permit discharge of system effluent in a fixed direction, typically rearward from the vehicle. Such devices are therefore impractical where the rearward discharge of system effluent is inappropriate (e.g., houses, vehicles, or poor drainage areas lie rearward from the vehicle) and the vehicle cannot be oriented to change the direction of discharge.

To this extent, a need exists for a device for dispersing and/or distributing a fluid from a pressurized system that does not suffer from the deficiencies of known devices.

### SUMMARY OF THE INVENTION

The invention provides a device for dispersing and/or distributing a fluid effluent from a pressurized fluid system. In one embodiment, a device according to the invention includes a hitch member adapted for attachment to a vehicle; and a tubular member having at least one discharge opening and at least one attachment port adapted for attachment to a pressurized liquid system, wherein at least a portion of the tubular member is adapted to be variously oriented in at least one of the following: a horizontal position and a vertical position and wherein a pressure of a liquid entering the at least one attachment port is greater than a pressure of a liquid exiting the at least one discharge opening.

A first aspect of the invention provides a device for dispersing a liquid comprising: a hitch member adapted for attachment to a vehicle; and a tubular member having at least one discharge opening and at least one attachment port adapted for attachment to a pressurized liquid system, wherein at least a portion of the tubular member is adapted to be variously oriented in at least one of the following: a horizontal position and a vertical position.

A second aspect of the invention provides a device for distributing a pressurized fluid comprising: a hitch member adapted for attachment to a vehicle; and a tubular member having at least one discharge port and at least one receiving port, wherein a fluid exiting the at least one discharge port has a pressure greater than a fluid entering the at least one receiving port.

A third aspect of the invention provides a device for dispersing a liquid comprising: a hitch member adapted for attachment to a vehicle; a tubular member having at least one discharge opening and at least one attachment port adapted for attachment to a pressurized liquid system; and a diffusing device connected to the at least one discharge opening, the diffusing device having a mesh member including a plurality of openings through which a liquid may be dispersed, wherein at least one of the diffusing device and a portion of the tubular member is adapted to be variously oriented in at least one of the following: a horizontal position and a vertical position.

A fourth aspect of the invention provides a device for dispersing a liquid comprising: a hitch member adapted for attachment to a vehicle; a tubular member having at least one discharge opening and at least one attachment port adapted for attachment to a pressurized liquid system; and a dechlorinating device connected to the at least one discharge opening, the dechlorinating device having: a mesh member including a plurality of openings through which a liquid may be dispersed; and a tube member within the dechlorination device capable of securing dechlorinating medium and through which a liquid may flow, wherein at least one of the dechlorinating device and a portion of the tubular member is adapted to be variously oriented in at least one of the following: a horizontal position and a vertical position.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a side view of a device according to the invention in relation to a vehicle to which it may be attached.

FIG. 2 shows a top view of the device of FIG. 1.

FIGS. 3A-C show illustrative alternative embodiments of a device according to the invention.

FIG. 4 shows a side elevational view of an alternative embodiment of a device according to the invention.

FIG. 5 shows a detailed view of the device of FIG. 4.

FIG. 6 shows a schematic view of a device according to the invention for distributing effluent from a pressurized fluid system.

FIG. 7 shows an elevational view of a diffusing device according to the invention.

FIG. 8 shows a partial cut-away elevational view of a dechlorinating device according to the invention.

FIG. 9 shows an elevational view of the dechlorinating device of FIG. 8 used in conjunction with the device of FIG. 1.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a device for dispersing and/or distributing a fluid effluent from a pressurized fluid system.

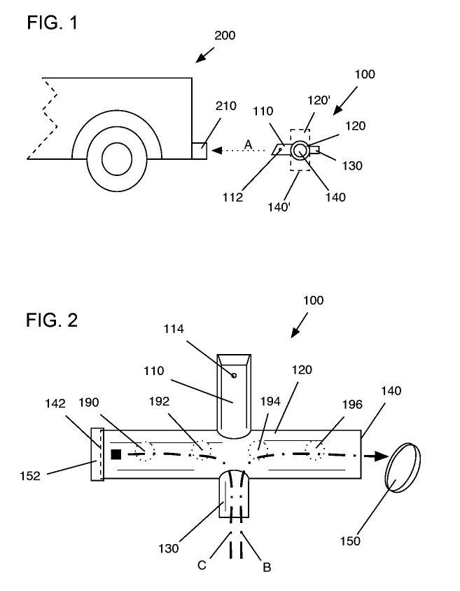

Turning now to the figures, FIG. 1 shows a device 100 according to the invention in relation to a vehicle 200 to which it may be attached. Hitch member 110 of device 100 is adapted to be attached to vehicle 200 by inserting hitch member 110 into hitch 210 along path A. Hitch member 110 may be adapted for use with any number of vehicle hitches, such as a class 3 hitch. Accordingly, hitch member 110 includes a horizontal slot 112 for receiving a hitch pin (not shown), whereby hitch member 110 may be attached to hitch 210. As will be explained in greater detail below, hitch member 110 may include more than one slot, such as a vertical slot, such that device 100 may alternately be oriented in a horizontal or vertical position.

Device 100 further includes a tubular member 120, the tubular member 120 having at least one discharge opening 140 for discharging effluent and at least one attachment port 130 for receiving effluent. Attachment port 130 is adapted to attach to a pressurized system, such as a system of fire hydrants. Accordingly, attachment port 130 may be adapted to attach to a fire hose or similar device for connecting device 100 and the pressurized system.

Tubular member 120 and/or attachment port 130 may be composed of any number of materials, as will be recognized by one skilled in the art. Suitable materials include, for example, aluminum, steel, and rigid plastic materials. Other materials may be used, of course, provided the materials are capable of withstanding the pressures imparted by the pressurized systems to which device 100 will be connected.

In the case that device 100 is oriented in a vertical position, tubular member 120′ (shown in phantom) is oriented vertically, such that discharge opening 140′ (shown in phantom) faces downward (or, less preferably, upward). The ability to alternately orient device 100 in a horizontal or vertical position permits the discharge of effluent in whatever direction is more appropriate. For example, in the case that the vehicle 200 may be located adjacent a storm drain (not shown), orientation of device 100 in a vertical position allows effluent to be discharged directly into the storm drain.

FIG. 2 shows a top view of device 100. As shown, tubular member 120 includes a pair of discharge openings 140, 142, one at either end of tubular member 120. Hitch member 110 includes a vertical slot 114, permitting the vertical orientation of device 100, as described above. Device 100 further includes a pair of cap member 150, 152 for alternately sealing and opening discharge openings 140, 142. Cap members 150, 152 may be secured to tubular member 120 by any number of techniques, as will be recognized by one skilled in the art. Suitable techniques include, for example, clamps, nuts and bolts, and corresponding threaded members on an exterior surface of tubular member 120 and an internal surface of cap members 150, 152. In a preferred embodiment, cap members 150, 152 are storz caps.

When used to disperse effluent from a pressurized system, such as a system of fire hydrants, attachment port 130 is attached to the pressurized system using, for example, a fire hose. Accordingly, attachment port 130 may include any number of attachment devices, as will be recognized by one skilled in the art. Preferably, attachment port 130 includes threads on its exterior surface for attachment to a fire hose.

Once device 100 is connected to the pressurized system, effluent enters device 100 through attachment port 130 (i.e., along paths B and C) and into tubular member 120. In the case that a discharge opening is open (as with discharge opening 140), effluent exits tubular member 120 in a direction substantially perpendicular to the direction in which it entered device 100 (i.e., through attachment port 130). In the case that discharge opening is capped (as with discharge opening 142), effluent is prevented from exiting tubular member 120 through the capped discharge opening.

In the event that device 100 is used to disperse effluent from a system having a very high pressure or it is desirable to quickly disperse such effluent, device 100 may further comprise one or more drains 190, 192, 194, 196 (shown in phantom) in a wall of tubular member 120. Such drains provide additional paths for the system effluent to be dispersed through device 120, thereby dispersing the effluent at a lower pressure and/or more quickly.

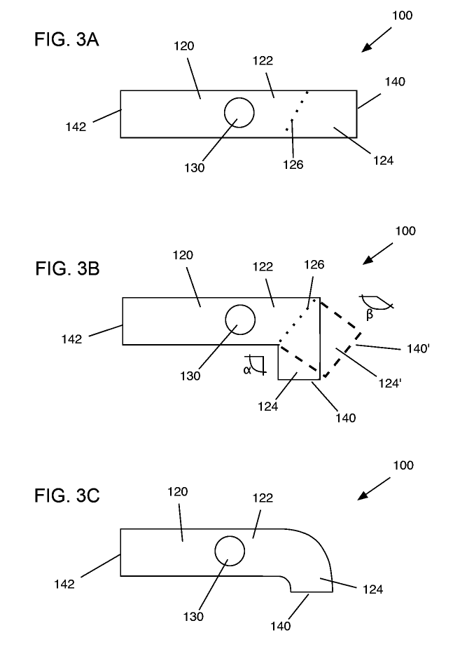

FIGS. 3A-C show schematic views of alternative embodiments of the invention in which a first portion 124 of tubular member 120 is adapted to be oriented in a direction different from a second portion 122 of tubular member 120. For example, FIG. 3A shows one embodiment of a device 100 according to the invention, wherein first portion 124 may be rotated about a joint 126. The diagonal orientation of joint 126 permits first portion 124 to be oriented in any number of directions relative to second portion 122. As shown in FIG. 3A, first portion 124 is rotated such that it is in line with second portion 122.

In FIG. 3B, however, first portion 124 has been rotated such that it forms an angle (alpha) relative to second portion 122. In such an orientation, effluent may exit discharge opening 140 in a direction substantially perpendicular to both attachment port 130 and second portion 122 of tubular member 120. Any number of alternative angles may be formed between first portion 124 and second portion 122. For example first portion 124′ (shown in phantom) may be rotated about joint 126 such that first portion 124′ forms a shallower angle (beta) relative to second portion 122. In this orientation, effluent may exit discharge opening 140′ (shown in phantom) in a direction substantially perpendicular to attachment port 130 but not perpendicular to second portion 122 of tubular member 120.

In FIG. 3C, yet another alternative embodiment of device 100 is shown. Rather than utilizing a variable joint 126, as in FIG. 3B, first portion 124 may form a fixed angle relative to second portion 122 of tubular member 120.

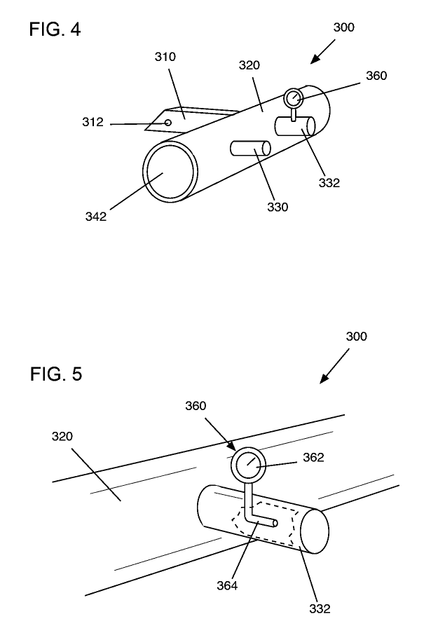

Referring now to FIGS. 4-5, another alternative embodiment of the invention is shown. In FIG. 4, tubular member 320 includes a pair of attachment ports 330, 332, wherein a diameter of the first attachment port 330 is smaller than a diameter of the second attachment port 332. Such an arrangement permits the connection of device 300 to pressurized systems using devices (e.g., fire hoses) of different diameters.

In the case that it may be desirable to measure a pressure of the pressurized system to which device 300 is connected, one or more attachment ports 330, 332 may include a pressure-measuring device 360. FIG. 5 shows a detailed view of second attachment port 332 (partially cut away) and pressure-measuring device 360. Pressure-measuring device 360 includes a Pitot tube 364 and pressure gauge 362. Other suitable devices for measuring the pressure of fluids entering device 300 via an attachment port will be known to one having skill in the art.

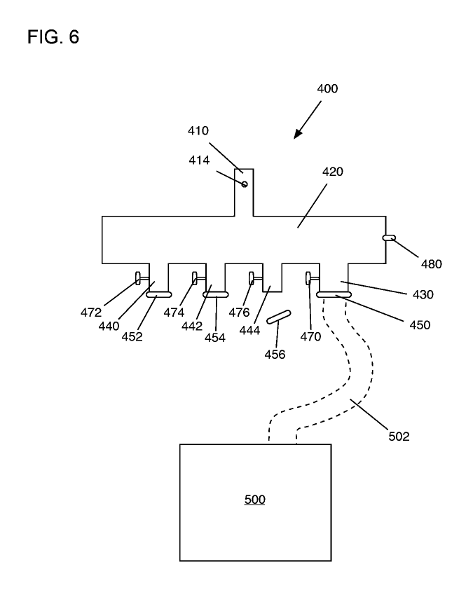

In some cases, a device useful for dispersing effluent of a pressurized system may similarly be useful in distributing such effluent. For example, such a device may be used to distribute effluent from a pressurized system having a single outlet to a plurality of outlets. FIG. 6 shows a schematic view of an illustrative device 400 for distributing effluent of a pressurized fluid system. In many cases, such a fluid will be a liquid. However, in some cases, a fluid may be in the form of a non-liquid fluid, such as a foam.

The device of FIG. 6 may be employed, for example, in a firefighting context, particularly where water or another fluid is distributed from a portable storage system, such as a tank truck. Device 400 includes a single attachment port 430 and a plurality of discharge openings 440, 442, 444. As such, attachment port 430 may be connected to the liquid storage tank 500 of the tank truck using a fire hose 502 (shown in phantom) and the storage tank effluent distributed through fire hoses (not shown) connected to the discharge openings 440, 442, 444. Attachment port 430 and discharge openings 440, 442, 444 may each include a cap member 450, 452, 454, 456, as described above.

A diameter of attachment port 430 may be greater than the diameters of discharge openings 440, 442, 444, as shown. Such an arrangement may be useful, for example, in maintaining a pressure of the system, in the case that the system effluent is distributed through more than one discharge opening 440, 442, 444. Similarly, one or more of the attachment port 430 and the plurality of discharge openings 440, 442, 444 may include a valve member 470 and 472, 474, 476, respectively, for varying the size of the attachment port 430 or discharge opening 440, 442, 444, thereby controlling the flow of effluent into and out of device 400. As described above with respect to FIGS. 4-5, device 400 may include more than one attachment port, each having a different diameter. Similarly, one or more of the plurality of discharge openings 440, 442, 444 may have a diameter different than another of the plurality of discharge openings 440, 442, 444.

In the case that a pressure of a fluid within tubular member 420 must be prevented from exceeding a particular level, a pressure relief valve 480 may optionally be included in a wall of tubular member 420. The inclusion of pressure relief valve 480 may be desired, for example, in a firefighting context, where the pressure of effluent entering a fire hose attached to a discharge opening 440, 442, 446 must be below a particular value to avoid the rupture of or difficulty in controlling the fire hose. Pressure relief valve 480 may be adapted, for example, to open when a pressure within tubular member 420 exceeds a value between about 50 pounds per square inch (p.s.i.) and about 200 p.s.i. and remain open until the pressure falls below a pressure between about 50 p.s.i. and about 200 p.s.i. In order to monitor a pressure of an effluent exiting device 400, one or more discharge openings 440, 442, 444 may include a pressure-measuring device (not shown), as described above with respect to FIGS. 4-5.

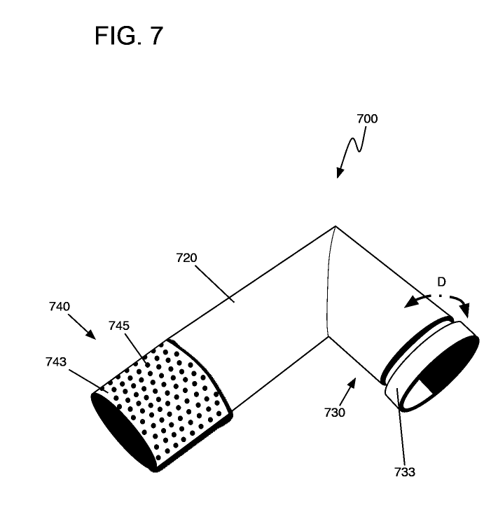

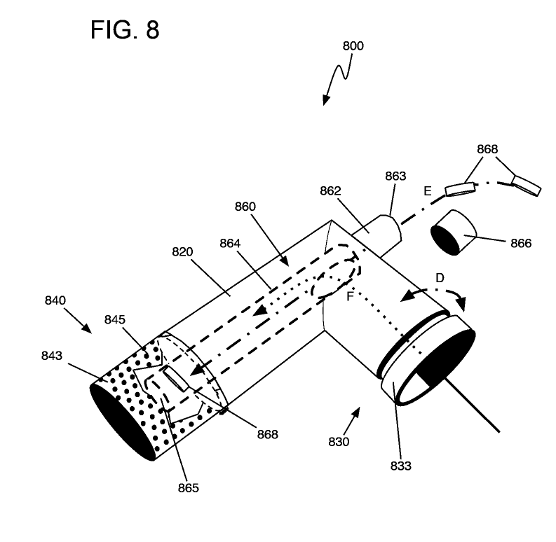

FIGS. 7 and 8 show a diffusing device 700 and a dechlorinating device 800 according to the invention, which may be used in conjunction with a device described above (e.g., device 100 in FIG. 2). As such, diffusing device 700 includes a tubular member 720 having an attachment port 730, which may be connected to discharge opening 140 (FIG. 2) using a coupling 733. Preferably, coupling 733 is movable along path D around an axis of diffusing device 700 such that discharge opening 740 may be variously oriented.

Unlike other discharge openings described above (e.g., discharge opening 140 in FIG. 2), discharge opening 740 comprises a mesh sleeve 743 having a plurality of openings 745, through which effluent entering attachment port 730 and traveling through tubular member 720 may exit diffusing device 700. Thus, discharge opening 740 diffuses the effluent such that it exerts a greatly reduced force upon surfaces onto which it is discharged. This may be particularly desirable, for example, where the effluent is to be discharged onto a surface composed of gravel or other loose aggregate, which may be dislodged by the undiffused flow of the effluent, causing damage to the surface and a hazard to adjacent property or individuals.

In FIG. 8, a dechlorinating device 800 is shown, wherein a device similar to diffusing device 700 (FIG. 7) also includes a dechlorination tube 860. Dechlorination tube 860 includes an exterior portion 862 and an interior portion 864, through which the effluent may flow F. Dechlorination tablets 868 may be fed E into dechlorination tube 860 through an opening 863 in the exterior portion 862 and held within dechlorination tube 860 by a closed end 865 of the interior portion 864. Exterior portion 862 preferably includes a cap 866 to prevent the escape of effluent and/or the loss of dechlorination tablets 868.

Dechlorination tablets 868 are commercially available from a number of sources. For example, Integra Chemical Company of Renton, Wash. offers Vita-D-Chlor™ tablets comprising ascorbic acid or sodium ascorbate. Sulfur tablets may also be used to neutralize chlorine in the effluent. In addition, while shown in FIG. 8 as dechlorination tablets 868, other dechlorination media may also be used. For example, a dechlorinating compound may be added to dechlorination tube 860 in powder or crystal form.

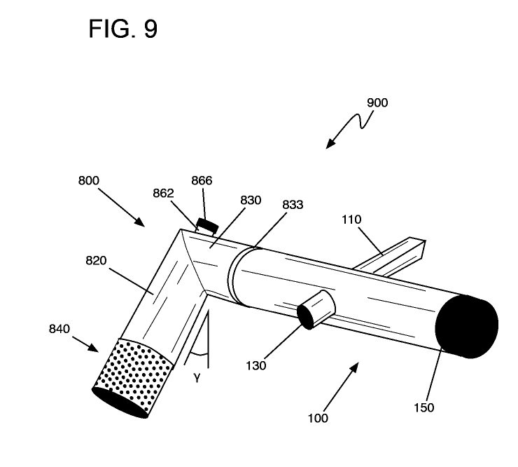

Finally, FIG. 9 shows a dechlorinating apparatus 900 comprising device 100 of FIG. 2 and dechlorinating device 800 of FIG. 8. As can be seen in FIG. 9, coupling 833 permits dechlorinating device 800 to be angled γ relative to device 100.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A device for dispersing a liquid comprising:
a hitch member adapted for attachment to a vehicle;
a tubular member having at least one discharge opening and at least one attachment port adapted for attachment to a pressurized liquid system; and
a diffusing device connected to the at least one discharge opening, the diffusing device having a mesh member including a plurality of openings through which a liquid may be dispersed,
wherein at least one of the diffusing device and a portion of the tubular member is adapted to be variously oriented in at least one of the following: a horizontal position or a vertical position.

2. The device of claim 1, wherein the pressurized liquid system is selected from a group consisting of: a system of fire hydrants, a sprinkler system, and a liquid storage tank.

3. The device of claim 1, wherein a pressure of a liquid entering the at least one attachment port is greater than a pressure of a liquid exiting the at least one discharge opening.

4. The device of claim 1, wherein a pressure of a liquid entering the at least one attachment port is less than a pressure of a liquid exiting the at least one discharge opening.

5. The device of claim 1, wherein a first portion of the tubular member is adapted to be angled relative to a second portion of the tubular member.

6. The device of claim 5, wherein the first portion includes at least one discharge opening, such that a liquid may exit the at least one discharge opening at an angle relative to the second portion of the tubular member.

7. The device of claim 1, wherein the tubular member includes at least two attachment ports, a first attachment port having a first diameter and a second attachment port having a second diameter greater than the first diameter.

8. The device of claim 7, wherein the first attachment port is adapted to be connected to a first pressurized liquid system and the second attachment port is adapted to be connected to a second pressurized liquid system.

9. The device of claim 1, further comprising:
a cap member for alternately sealing and opening the at least one discharge opening.

10. The device of claim 1, further comprising:
a device for measuring a pressure of a liquid entering the at least one attachment port.

11. The device of claim 1, further comprising:
at least one valve device adapted to vary a size of an opening of at least one of the at least one attachment port and the at least one discharge opening.

12. A device for dispersing a liquid comprising:
a hitch member adapted for attachment to a vehicle;
a tubular member having at least one discharge opening and at least one attachment port adapted for attachment to a pressurized liquid system; and
a dechlorinating device connected to the at least one discharge opening, the dechlorinating device having:
a mesh member including a plurality of openings through which a liquid may be dispersed; and
a tube member within the dechlorination device capable of securing a dechlorinating medium and through which a liquid may flow,
wherein at least one of the dechlorinating device and a portion of the tubular member is adapted to be variously oriented in at least one of the following: a horizontal position or a vertical position.

13. The device of claim 12, wherein the pressurized liquid system is selected from a group consisting of: a system of fire hydrants, a sprinkler system, and a liquid storage tank.

14. The device of claim 12, wherein a pressure of a liquid entering the at least one attachment port is greater than a pressure of a liquid exiting the at least one discharge opening.

15. The device of claim 12, wherein a pressure of a liquid entering the at least one attachment port is less than a pressure of a liquid exiting the at least one discharge opening.

16. The device of claim 12, wherein a first portion of the tubular member is adapted to be angled relative to a second portion of the tubular member.

17. The device of claim 16, wherein the first portion includes at least one discharge opening, such that a liquid may exit the at least one discharge opening at an angle relative to the second portion of the tubular member.

18. The device of claim 12, wherein the tubular member includes at least two attachment ports, a first attachment port having a first diameter and a second attachment port having a second diameter greater than the first diameter, and wherein the first attachment port is adapted to be connected to a first pressurized liquid system and the second attachment port is adapted to be connected to a second pressurized liquid system.

19. The device of claim 12, wherein the dechlorinating medium is selected from a group consisting of: dechlorinating powders, dechlorinating tablets, and dechlorinating crystals.

20. The device of claim 12, further comprising:
a device for measuring a pressure of a liquid entering the at least one attachment port.
